(19) United States
(12) Patent Application Publication
(10) Pub. No.: US 2018/0011661 A1
(43) Pub. Date: Jan. 11, 2018

(54) DATA LOCALITY IN A HYPERCONVERGED COMPUTING SYSTEM

(71) Applicant: HEWLETT PACKARD ENTERPRISE DEVELOPMENT COMPANY LP, Houston, TX (US)

(72) Inventor: Rajiv Madampath, Bangalore (IN)

(21) Appl. No.: 15/336,960

(22) Filed: Oct. 28, 2016

(30) Foreign Application Priority Data
Jul. 9, 2016 (IN) 201641023554

(51) Int. Cl. G06F 3/06

(52) U.S. Cl. CPC G06F 3/0659; G06F 12/109; G06F 3/0664; G06F 3/0673; G06F 3/0611; G06F 2212/1024; G06F 2212/152; G06F 2212/657

(57) ABSTRACT

Some examples describe data locality solutions for a hyperconverged computing system. In an example, a data request may be received at a Virtual Storage Appliance (VSA) node amongst a plurality of VSA nodes in a hyperconverged computing system. A determination may be made whether a remapped logical block address (LBA) associated with the data request is included on a first mapping layer on the VSA node. In response to a determination that the remapped LBA associated with the data request is present on the first mapping layer of the VSA node, the remapped LBA may be used to resolve the data request. In response to a determination that the remapped LBA associated with another data request is not present on the first mapping layer of the VSA node, a second mapping layer on the VSA node may be used to resolve the other data request.

### BACKGROUND

A hyperconverged infrastructure may refer to an IT infrastructure system that is largely software defined with tightly integrated compute, storage, and networking resources. In a hyperconvergence environment storage, compute and network components may be optimized to work together on a single appliance.

### BRIEF DESCRIPTION OF THE DRAWINGS

For a better understanding of the solution, examples will now be described, purely by way of example, with reference to the accompanying drawings, in which:

FIG. 1 is a block diagram of an example hyperconverged computing system for providing data locality;

FIG. 2 is a block diagram of an example computing system for providing data locality in a hyperconverged computing system;

FIG. 3 is a flowchart of an example method of providing data locality in a hyperconverged computing system; and

FIG. 4 is a block diagram of an example system for providing data locality in a hyperconverged computing system.

### DETAILED DESCRIPTION

Hyperconvergence may be considered as the next stage in the evolution of IT architectures that brings together the benefits of converged infrastructure, virtualization, and software-defined storage technologies. Various components of an IT infrastructure, for example, servers, storage, virtualization software, networking, and management may be integrated and packaged together into a single and highly available appliance. Hyperconvergence may provide a virtualization environment with highly efficient scalability.

A hyperconverged computing system or platform may include a plurality of nodes. These nodes may store volume data that may be distributed across multiples nodes. In an example, if a compute virtual machine (VM) that may be co-located with a storage virtual machine (for example, a virtual storage appliance (VSA)) on a node may frequently request for volume data. In the event the logical block address (LBA) associated with the requested data maps to another node, the requests may need to be forwarded to the other node since the data may not be available locally. This may not be a desirable scenario since it may lead to operational and performance bottlenecks.

To address this issue, the present disclosure describes a data locality solution for a hyperconverged computing system. In an example, a data request may be received at a Virtual Storage Appliance (VSA) node amongst a plurality of VSA nodes in a hyperconverged computing system. A determination may be made whether a remapped logical block address (LBA) associated with the data request is included on a first mapping layer on the VSA node. In response to the determination that the remapped LBA associated with the data request is present on the first mapping layer of the VSA node, the remapped LBA may be used to resolve the data request. On the other hand, in response to the determination that the remapped LBA associated with another data request is not present on the first mapping layer of the VSA node, a second mapping layer on the VSA node may be used to resolve the other data request.

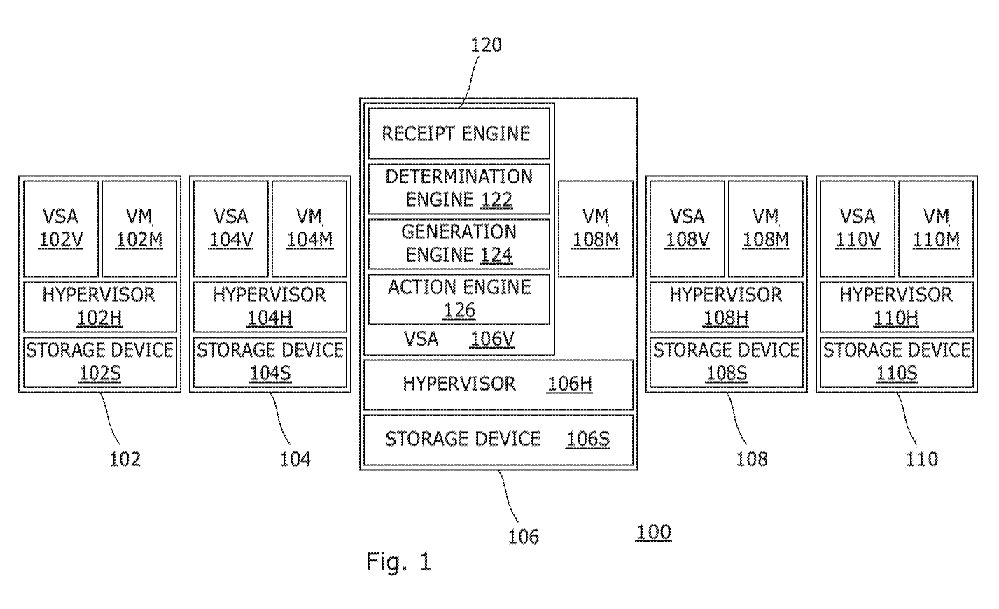

FIG. 1 is a block diagram of an example hyperconverged computing system 100 for providing data locality. In an example, hyperconverged computing system may include a plurality of nodes 102, 104, 106, 108, and 110. As used herein, a “node” may be a computing device (i.e. includes at least one processor), a storage device, a network device, or any combination thereof. Although five nodes are shown in FIG. 1, other examples of this disclosure may include more or less than five nodes.

In an example, nodes 102, 104, 106, 108, and 110 may each be a computing device such as a server, a desktop computer, a notebook computer, a tablet computer, a mobile phone, a personal digital assistant (PDA), and the like.

Nodes 102, 104, 106, 108, and 110, may be communicatively coupled, for example, via a computer network. Computer network may be a wireless or wired network. Computer network may include, for example, a Local Area Network (LAN), a Wireless Local Area Network (WAN), a Metropolitan Area Network (MAN), a Storage Area Network (SAN), a Campus Area Network (CAN), or the like. Further, computer network may be a public network (for example, the Internet) or a private network (for example, an intranet).

In an example, nodes 102, 104, 106, 108, and 110 may each include a hypervisor (for example, 102H, 104H, 106H, 108H, and 110H, respectively). A hypervisor is a hardware virtualization layer that abstracts processor, memory, storage and network resources of a hardware platform and allows one or multiple operating systems (termed guest operating systems) to run concurrently on a host device. Virtualization allows the guest operating systems to run on isolated virtual environments (termed as virtual machines (VMs)). A computer system on which a hypervisor is running a virtual machine may be defined as a host machine. For instance, nodes 102, 104, 106, 108, and 110 may each act as a host machine. Any number of virtual machines may be hosted on a hypervisor.

Referring to FIG. 1, a hypervisor on each of the nodes may host one or multiple virtual machines. These may be termed as compute virtual machines. In an example, nodes 102, 104, 106, 108, and 110 may each include a virtual machine (for example, 102M, 104M, 106M, 108M, and 110M, respectively). Virtual machines may each be used for a variety tasks, for example, to run multiple operating systems at the same time, to test a new application on multiple platforms, etc. In an example, nodes 102, 104, 106, 108, and 110 may each host a virtual storage appliance (VSA) (for example, 102V, 104V, 106V, 108V, and 110V, respectively).

A virtual storage appliance (VSA) may be defined as an appliance running on or as a virtual machine that may perform an operation related to a storage system. In an example, a virtual storage appliance may virtualize storage resources of a node (for example, 102). A node comprising a virtual storage appliance may be termed as a “VSA node” (for example, 102, 104, 106, 108, and 110). In an example, a virtual storage appliance may create a virtual shared storage using direct-attached storage in a node hosting a hypervisor. In the event there is a plurality of nodes, for example in a hyperconverged computing system (for example, 100), a virtual storage appliance may create a virtual shared storage using direct-attached storage of one or a plurality of nodes (for example, 102, 104, 106, 108, and 110) to create a virtual array within and across a plurality of nodes. The virtual shared storage may be shared across a plurality of nodes. A virtual storage application may use a host network (for example, an Ethernet network) as a storage backplane to present storage via a suitable protocol (for example, iSCSI) to a plurality of nodes and virtual machines hosted on such nodes. In an example, a virtual storage appliance may virtualize an external storage unit (for example, an external disk array) and make the resultant virtual storage available to one or multiple nodes (for example, 102, 104, 106, 108, and 110).

In an example, nodes 102, 104, 106, 108, and 110 may each include a storage device (for example, 102S, 104S, 106S, 108S, and 110S, respectively). Storage devices 102S, 104S, 106S, 108S, and 110S may each include a non-transitory machine-readable storage medium that may store, for example, machine executable instructions, data file, and metadata related to a data file. Some non-limiting examples of a non-transitory machine-readable storage medium may include a hard disk, a storage disc (for example, a CD-ROM, a DVD, etc.), a disk array, a storage tape, a solid state drive, a Serial Advanced Technology Attachment (SATA) disk drive, a Fibre Channel (FC) disk drive, a Serial Attached SCSI (SAS) disk drive, a magnetic tape drive, and the like.

Storage devices 102S, 104S, 106S, 108S, and 110S may each be a direct-attached storage i.e. storage that is directly attached to its respective node (i.e. nodes 102, 104, 106, 108, and 110). In an example, storage devices 102S, 104S, 106S, 108S, and 110S may each be an external storage (for example, a storage array) that may communicate with its respective node (i.e. nodes 102, 104, 106, 108, and 110) via a communication interface. Storage devices 102S, 104S, 106S, 108S, and 110S) may communicate with their respective nodes via a suitable protocol such as, but not limited to, Fibre Connection (FICON), Internet Small Computer System Interface (iSCSI), HyperSCSI, and ATA over Ethernet.

In an example, VSA nodes 102, 104, 106, 108, and 110 may each include a receipt engine 120, a determination engine 122, a generation engine 124, and an action engine 126. For the sake of simplicity, VSA 106V in node 106 in FIG. 1 is shown to include receipt engine 124, determination engine 122, generation engine 124, and action engine 126, but in other examples, other VSA nodes (for example, 102V, 104V, 108V, and 110V) may include these engines as well. A VSA node (for example, 102) may be implemented by at least one computing device and may include at least engines 120, 122, 124, and 126, which may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of a VSA node (for example, 102). In some examples, the at least one machine-readable storage medium may store instructions that, when executed by the at least one processing resource, at least partially implement some or all engines of a VSA node (for example, 102). In such examples, a VSA node (for example, 102) may include the at least one machine-readable storage medium storing the instructions and the at least one processing resource to execute the instructions.

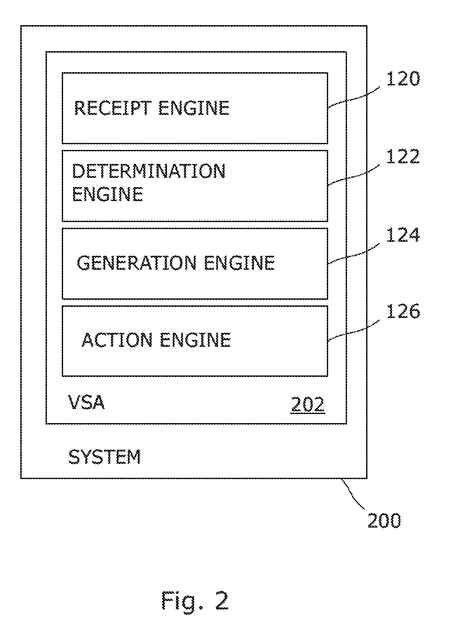

The functionalities performed by receipt engine 120, determination engine 122, generation engine 124, and action engine 126 are described in reference to FIG. 2 below.

FIG. 2 is a block diagram of an example computing system 200 for providing data locality in a hyperconverged computing system. In an example, computing system 200 may be analogous to a node (for example, 102, 104, 106, 108, and 110) of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

In an example, system 200 may represent any type of computing device capable of reading machine-executable instructions. Examples of computing device may include, without limitation, a server, a desktop computer, a notebook computer, a tablet computer, a thin client, a mobile device, a personal digital assistant (PDA), a phablet, and the like. In an example, system 200 may be a VSA node in a hyperconverged computing system (for example 100) that may include a plurality of VSA nodes.

System 200 may include a Virtual Storage Appliance (VSA) 202. In an example, VSA 202 may be similar to a VSA of FIG. 1 (for example, 102V, 104V, 106V, 108V, and 110V). Virtual storage appliance (VSA) 202 may be an appliance running on or as a virtual machine that may perform an operation related to a storage system. In an example, virtual storage appliance 202 may virtualize storage resources of system 200. A system comprising a virtual storage appliance may be termed as a “VSA node” (for example, 200). Virtual storage appliance may be hosted on a hypervisor in system 200. In an example, virtual storage appliance 202 may create a virtual shared storage using direct-attached storage in computing system. In the event system 200 is a node amongst a plurality of nodes, for example, in a hyperconverged computing system (for example, 100), virtual storage appliance 202 may create a virtual shared storage using direct-attached storage of one or a plurality of nodes to create a virtual array within and across a plurality of nodes. The virtual shared storage may be shared across the plurality of nodes.

In an example, VSA 202 may include a receipt engine 120, a determination engine 122, a generation engine 124, and an action engine 126. System 200 may be implemented by at least one computing device and may include at least engines 120, 122, 124, and 126, which may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of system 200. In some examples, the at least one machine-readable storage medium may store instructions that, when executed by the at least one processing resource, at least partially implement some or all engines of system 200. In such examples, system 200 may include the at least one machine-readable storage medium storing the instructions and the at least one processing resource to execute the instructions.

Receipt engine 120 may be used to receive a request for volume data. The data request may be provided by a component, which may be received at receipt engine 120. In an example, the data request may be provided by a virtual machine that may be co-located with VSA 202 on system 200. In another example, the data request may be received from another computer system. In an example, system 200 may be a node amongst a plurality of nodes, for example, in a hyperconverged computing system (for example, 100). In this case, the data request may be received from another VSA node in the hyperconverged computing system. The data request may include, for example, a read or write request and/or an input or output request.

Further to receipt of a data request by the receipt engine 120, determination engine 122 may proceed to determine a logical block address (LBA) associated with the data request. In this regard, determination engine 122 may first determine whether a first mapping layer exists on system 200. In an example, system 200 may include a first mapping layer and a second mapping layer. The first mapping layer, if present, may include a remapped logical block address (LBA) associated with the data request. The second mapping layer may be used to apply modulo arithmetic on an incoming LBA request to determine a VSA node that the LBA maps to and forwards the request to that node.

In the event a determination is made that a first mapping layer exists on system 200, the determination engine 122 may determine whether the first mapping layer includes a remapped logical block address (LBA) associated with the data request. In response to the determination that the remapped LBA associated with the data request is present in the first mapping layer of system 200, action engine 126 may use the remapped LBA to resolve the data request. In the event the LBA request maps to another VSA node, action engine 126 may forward the request to that node. On the other hand, in the event it is determined that the remapped LBA associated with the data request is not present in the first mapping layer of system, action engine 126 may use the second mapping layer on system 200 to resolve a data request. As mentioned earlier, the second mapping layer may apply modulo arithmetic on an incoming LBA request to determine a VSA node that the LBA maps to. Action engine 126 may then forward the request to that node.

Generation engine 124 may be used to generate the first mapping layer on system 200 that may include the remapped logical block address (LBA) associated with a data request. To that end, in an example, the generation engine 124 may determine whether an LBA associated with the data request maps to another VSA node, for example, in a hyperconverged computing platform that comprises a plurality of VSA nodes. In response to the determination that the LBA associated with the data request maps to another VSA node (for example, referred as “VSA2 node”), generation engine 124 may determine a recent page hit count of a page associated with the data request on system 200. In an example, the recent page hit count of a page associated with the data request may be based on a clock function wherein a daemon maybe used to update page statistics periodically to keep track of page usage patterns.

Once the recent page hit count of a page associated with the data request on system 200 is determined, system 200 may send the recent page hit count to VSA2 node. In an example, the recent page hit count may be sent to VSA2 node via a Remote Procedure Call (RPC).

Upon receiving the recent page hit count of the page associated with the data request from system 200, VSA2 node may compare the received value with a recent page hit count of the page associated with the data request (may be called “IbaPAGE”) on VSA2 node. Further to the comparison, if it is determined that the recent page hit count of the page associated with the data request on system 200 is greater than the recent page hit count of the page associated with the data request on VSA2 node, VSA2 node may migrate this page to system 200.

In an example, migration of the page associated with the data request on VSA2 node to system 200 may begin with VSA2 node sending a request (for example, via RPC) to system 200 for contents of a page on system 200. This latter page may be referred to as “victimPAGE”. The victimPAGE may be selected by system 200. Once system 200 receives the request from VSA2 node, system 200 may send the contents of victimPAGE to VSA2 node. Upon receiving contents of the victimPAGE, VSA2 node may read the contents of IbaPAGE into memory and write out the contents of victimPAGE into the location of IbaPAGE. VSA2 node may populate its own first mapping layer to reflect the new mapping for IbaPAGE and victimPAGE. Specifically, two entries may be updated—the entry for IbaPAGE may now point to system 200, and the entry for victim PAGE may now point to the page number for IbaPAGE. VSA2 node may send the contents of IbaPAGE to system 200.

Once system 200 receives the contents of IbaPAGE from VSA2 node, system 200 may copy the contents of IbaPAGE to the location of victimPAGE. System 200 may then update the first mapping layer to reflect the remapped address for IbaPAGE and victimPAGE. Thus, the remapped logical block address (LBA) associated with the data request may be stored in the first mapping layer on system 200, thereby completing the swap operation. Further to the update, if any new request for IbaPAGE is received, it may be resolved at system 200 since determination engine may determine whether a remapped logical block address (LBA) associated with the data request is included in the first mapping layer on system 200.

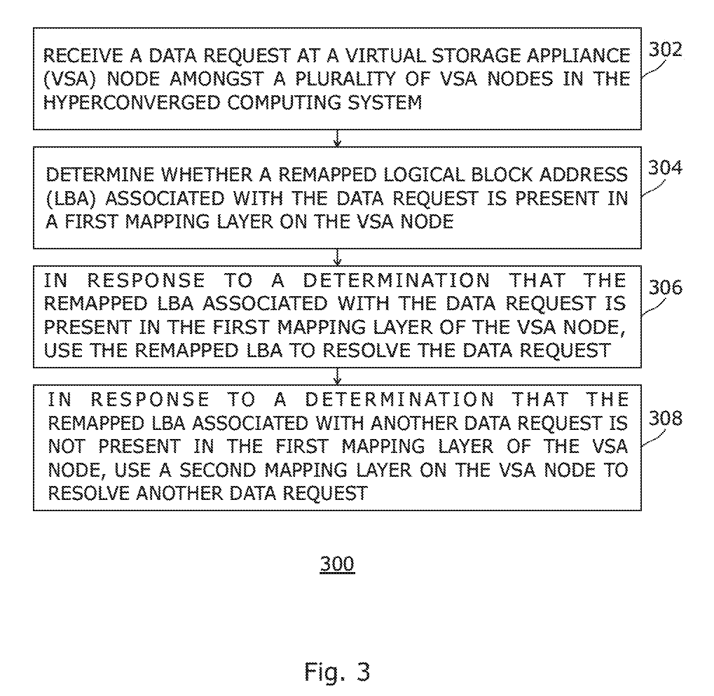

FIG. 3 is a flowchart of an example method 300 of providing data locality in a hyperconverged computing system. The method 300, which is described below, may be executed on a computing device such as a node (for example, 102, 104, 106, 108, and 110) of FIG. 1 or system of FIG. 2. However, other computing devices may be used as well. At block 302, a data request may be received at a Virtual Storage Appliance (VSA) node amongst a plurality of VSA nodes in a hyperconverged computing system. At block 304, a determination may be made whether a remapped logical block address (LBA) associated with the data request is included on a first mapping layer on the VSA node. At block 306, in response to a determination that the remapped LBA associated with the data request is present on the first mapping layer of the VSA node, the remapped LBA may be used to resolve the data request. At block 308, in response to a determination that the remapped LBA associated with another data request is not present on the first mapping layer of the VSA node, a second mapping layer on the VSA node may be used to resolve the other data request.

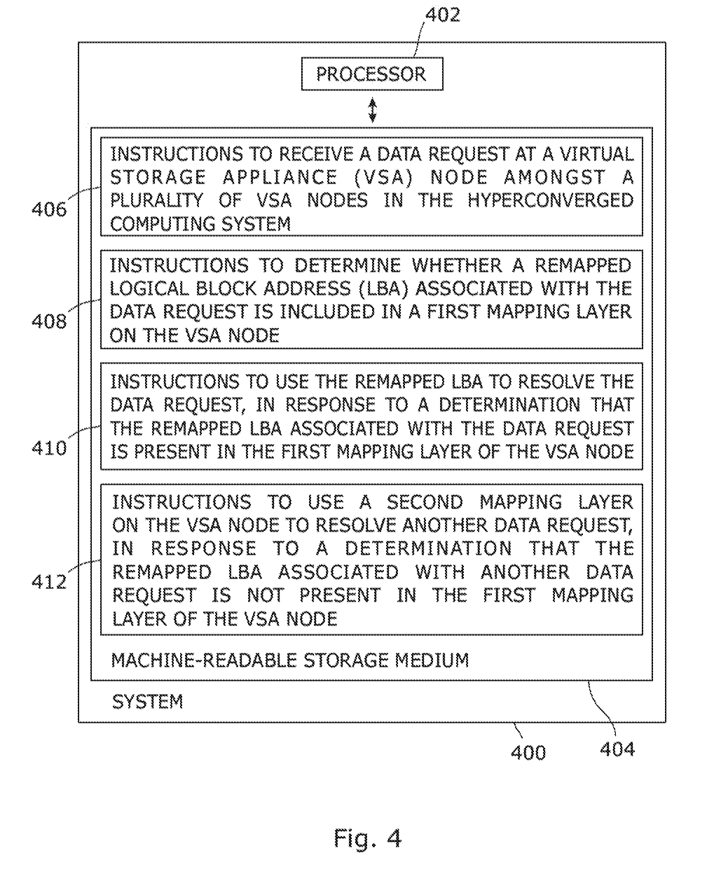

FIG. 4 is a block diagram of an example system 400 for providing data locality in a hyperconverged computing system. System 400 includes a processor 402 and a machine-readable storage medium 404 communicatively coupled through a system bus. In an example, system 400 may be analogous to a node (for example, 102, 104, 106, 108, and 110) of FIG. 1 or system of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 404 may store instructions 406, 408, 410, and 412. In an example, instructions 406 may be executed by processor 402 to receive a data request at a Virtual Storage Appliance (VSA) node amongst a plurality of VSA nodes in the hyperconverged computing system. Instructions 408 may be executed by processor 402 to determine whether a remapped logical block address (LBA) associated with the data request is included in a first mapping layer on the VSA node. Instructions 410 may be executed by processor 402 to use the remapped LBA to resolve the data request, in response to a determination that the remapped LBA associated with the data request is present in the first mapping layer of the VSA node. Instructions 412 may be executed by processor 402 to use a second mapping layer on the VSA node to resolve another data request, in response to the determination that the remapped LBA associated with another data request is not present in the first mapping layer of the VSA node.

For the purpose of simplicity of explanation, the example method of FIG. 3 is shown as executing serially, however it is to be understood and appreciated that the present and other examples are not limited by the illustrated order. The example systems of FIGS. 1, 2 and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution.

1. A method of data locality in a hyperconverged computing system, comprising:
receiving a data request at a Virtual Storage Appliance (VSA) node amongst a plurality of VSA nodes in the hyperconverged computing system;
determining whether a remapped logical block address (LBA) associated with the data request is present in a first mapping layer on the VSA node;
in response to a determination that the remapped LBA associated with the data request is present in the first mapping layer of the VSA node, using the remapped LBA to resolve the data request; and
in response to a determination that a remapped LBA associated with another data request is not present in the first mapping layer of the VSA node, using a second mapping layer on the VSA node to resolve the other data request.

2. The method of claim 1, further comprising generating the first mapping layer on the VSA node that includes the remapped logical block address (LBA) associated with the data request.

3. The method of claim 2, wherein generating the first mapping layer on the VSA node that includes the remapped logical block address (LBA) associated with the data request comprises:
determining whether an LBA associated with the data request maps to another VSA node in the plurality of nodes;
in response to the determination that the LBA associated with the data request maps to the another VSA node, determining a recent page hit count of a page associated with the data request on the VSA node;
comparing the recent page hit count of the page associated with the data request on the VSA node with a recent page hit count of the page associated with the data request on the another VSA node;
in response to the determination that the recent page hit count of the page associated with the data request on the VSA node is greater than the recent page hit count of the page associated with the data request on the another VSA node; and
receiving, at the VSA node, contents of the page associated with the data request on the another VSA node from the another VSA node.

4. The method of claim 3, further comprising:
determining the remapped logical block address associated with the data request further to the receipt; and
storing the remapped logical block address (LBA) associated with the data request in the first mapping layer on the VSA node.

5. The method of claim 3, wherein receiving contents of the page associated with the data request on the another VSA node from the another VSA node, comprises:
sending contents of a selected page on the VSA node to the another VSA node;
swapping contents of the selected page on the VSA node with contents of the page associated with the data request on the another VSA node;
receiving contents of the page associated with the data request on the another VSA node further to the swap; and
copying contents of the page associated with the data request on the another VSA node to a location of the selected page on the VSA node.

6. A computer system for data locality in a hyperconverged computing system, comprising:
a Virtual Storage Appliance (VSA), wherein the VSA includes:
a receipt engine to receive a data request;
a determination engine to determine whether a remapped logical block address (LBA) associated with the data request is included in a first mapping layer on the computer system;
a generation engine to generate the first mapping layer; and
an action engine to:
in response to a determination that the remapped LBA associated with the data request is present in the first mapping layer of the computer system, use the remapped LBA to resolve the data request; and
in response to a determination that the remapped LBA associated with another data request is not present in the first mapping layer of the computer system, use a second mapping layer on the computer system to resolve the other data request,

7. The system of claim 6, wherein the generation engine to:
determine whether an LBA associated with the data request maps to another node in the hyperconverged computing system, wherein the another node includes another VSA;
in response to the determination that the LBA associated with the data request maps to the another node, determine a recent page hit count of a page associated with the data request on the computing system;
compare the recent page hit count of the page associated with the data request on the computing system with a recent page hit count of the page associated with the data request on the another node;
in response to the determination that the recent page hit count of the page associated with the data request on the computing system is greater than the recent page hit count of the page associated with the data request on the another node, receive contents of the page associated with the data request on the another node from the another node;
determine the remapped logical block address associated with the data request further to the receipt; and
store the remapped logical block address (LBA) associated with the data request in the first mapping layer on the computing system.

8. The system of claim 6, wherein the data request is received from a virtual machine (VM) located on the system.

9. The system of claim 6, wherein the data request is received from a node of the hyperconverged computing system.

10. The system of claim 6, wherein the VSA is a virtual machine on the system.

11. A non-transitory machine-readable storage medium comprising instructions for data locality in a hyperconverged computing system, the instructions executable by a processor to:
receive a data request at a Virtual Storage Appliance (VSA) node amongst a plurality of VSA nodes in the hyperconverged computing system;
determine whether a remapped logical block address (LBA) associated with the data request is included in a first mapping layer on the VSA node;
in response to a determination that the remapped LBA associated with the data request is present in the first mapping layer of the VSA node, use the remapped LBA to resolve the data request; and
in response to a determination that the remapped LBA associated with another data request is not present in the first mapping layer of the VSA node, use a second mapping layer on the VSA node to resolve the other data request.

12. The storage medium of claim 11, wherein the instructions to use the second mapping layer to resolve the other data request comprises instructions to:
determine whether an LBA associated with the other data request maps to another VSA node in the plurality of nodes; and
in response to the determination that the LBA associated with the other data request maps to the another VSA node in the plurality of nodes, forward the other data request to the another VSA node to resolve the other data request.

13. The storage medium of claim 11, further comprising instructions to:
determine whether an LBA associated with the data request maps to another VSA node in the plurality of nodes;
in response to the determination that the LBA associated with the data request maps to the another VSA node, determine a recent page hit count of a page associated with the data request on the VSA node;
compare the recent page hit count of the page associated with the data request on the VSA node with a recent page hit count of the page associated with the data request on the another VSA node;
in response to the determination that the recent page hit count of the page associated with the data request on the VSA node is greater than the recent page hit count of the page associated with the data request on the another VSA node,
migrate contents of the page associated with the data request on the another VSA node, from the another VSA node to the VSA node;
determine the remapped logical block address associated with the data request further to the migration; and
store the remapped logical block address (LBA) associated with the data request in the first mapping layer on the VSA node.

14. The storage medium of claim 13, wherein the instructions to migrate contents of the page associated with the data request on the another VSA node, from the another VSA node to the VSA node include instructions to:
send contents of a page on the VSA node to the another VSA node;
swap contents of the page on the VSA node with contents of the page associated with the data request on the another VSA node; and
copy contents of the page associated with the data request on the another VSA node to a location of the page on the VSA node.

15. The storage medium of claim 14, further comprising instructions to update a first mapping layer on the another VSA node to include the remapped logical block address (LBA) associated with the data request.
